(19) United States
(12) Patent Application Publication
(10) Pub. No.: US 2024/0355507 A1
(43) Pub. Date: Oct. 24, 2024

(54) TUBE WITH SPOKES

(71) Applicant: Southwire Company, LLC, Carrollton, GA (US)

(72) Inventor: Jones KITHUKA, Newnan, GA (US)

(21) Appl. No.: 18/638,977

(22) Filed: Apr. 18, 2024

Related U.S. Application Data
(60) Provisional application No. 63/496,832, filed on Apr. 18, 2023.

(51) Int. Cl. H01B 7/42

(52) U.S. Cl. CPC H01B 7/423

(57) ABSTRACT

A liquid cooled conductor apparatus may be provided. The apparatus may comprise a conductor, a tube, and an extension element. The tube may be disposed around the conductor. The extension element may extend from an interior surface of the tube and may make contact with the conductor.

### RELATED APPLICATION

Under provisions of 35 U.S.C. § 119 (e), Applicant claims the benefit of U.S. Provisional Application No. 63/496,832, filed Apr. 18, 2023, which is incorporated herein by reference in its entirety.

### BACKGROUND

An Electric Vehicle (EV) charging system, also called an electric recharging point, a charging point, a charging station a charge point, and an Electric Vehicle Supply Equipment (EVSE), is an element in an infrastructure that supplies electric energy for recharging electric vehicles, such as plug-in electric vehicles, including electric cars, neighborhood electric vehicles, and plug-in hybrids. Because plug-in hybrid electric vehicles and battery electric vehicle ownership is expanding, there is a growing need for widely distributed publicly accessible charging stations, some of which support faster charging at higher voltages and currents than are available from residential EVSEs. Many charging stations are on-street facilities provided by electric utility companies or located at retail shopping centers and operated by private companies. These charging stations provide one or a range of heavy duty or special connectors that conform to the variety of electric charging connector standards.

### BRIEF DESCRIPTION OF THE FIGURES

The accompanying drawings, which are incorporated in and constitute a part of this disclosure, illustrate various embodiments of the present disclosure. In the drawings:

FIG. 1 shows a liquid cooled conductor apparatus; and

FIG. 2 shows a liquid cooled conductor apparatus.

### DETAILED DESCRIPTION

### Overview

A liquid cooled conductor apparatus may be provided. The apparatus may comprise a conductor, a tube, and an extension element. The tube may be disposed around the conductor. The extension element may extend from an interior surface of the tube, and may make contact with the conductor.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A charging system may be used to charge a battery or batteries, for example, an electric vehicle's batteries. Consistent with embodiments of the disclosure, electric vehicles may comprise, but are not limited to, electric cars, neighborhood electric vehicles, fork lifts, plug-in hybrids, etc. When batteries are charged, the time required to charge the batteries may be governed by the amount of current that a charging system can deliver to the batteries. One of the limiting factors for increasing the amount of charge current to the batteries and therefore reducing the amount of charge time may be the cable that connects an electric power source to the batteries.

Conventional systems may use an air cooled charging cable in battery charging applications, for example, in applications where the charging current is below 200 A. As the electric charging current increases above 200 A, the corresponding required size of the charging cable used to charge the batteries may become too large, too heavy, and too inflexible for a consumer to use. Consistent with embodiments of the disclosure, a liquid cooled charging cable may be provided. The liquid cooled charging cable may supply currents (e.g., 400 A to 1,000 A) that may be 2 to 5 times as much as the currents supplied by the conventional air cooled charging cable.

Consistent with embodiments of the disclosure, liquid coolant from a cooling device may be pumped directly around electrical conductors (e.g., bare, uninsulated). Accordingly, cooling of the electrical conductor by the coolant may greatly limit thermal resistance in the electrical conductors due to heating caused by high electrical currents in these components.

Resistance in a conductor may increase with temperature. The total power loss (i.e., 12R loss) along the supply and return paths may be lowered on some of the conductors in the charging cable by having a coolant flow over a conductor. A lower loss cable may result in less waste heat needing to be removed and lower operating temperature for the cable. This may be important as megawatt charging cables may be designed for faster vehicle charging. Limiting factors in the charging cable design may be material temperature limitations, boiling point limitations for the cooling fluid, or limitations of maximum safe handling temperatures on the outer surfaces of the charging cable.

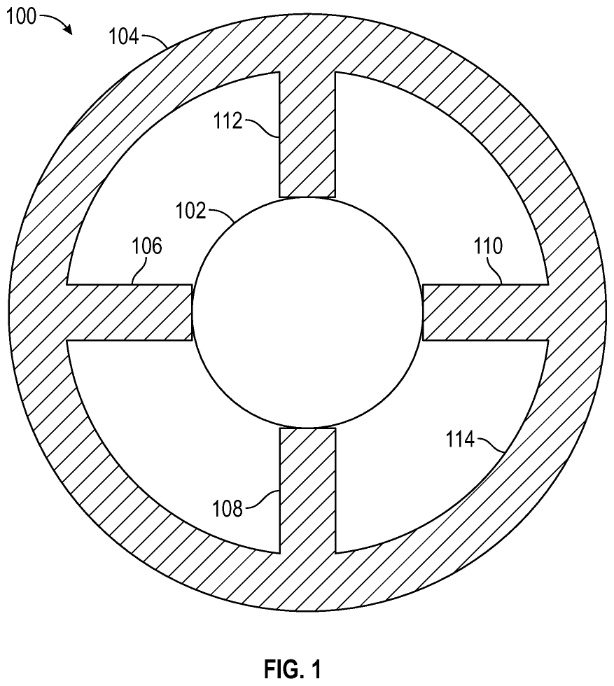

FIG. 1 shows a liquid cooled conductor apparatus 100. Apparatus 100 may comprise a conductor 102 (e.g., bare or insulated), a tube 104, and an extension element (e.g., a first spoke 106, a second spoke 108, a third spoke 110, and a fourth spoke 112). While FIG. 1 shows four spokes, embodiments of the disclosure may comprise any number of spokes and is not limited to four. Tube 104 may be disposed around conductor 102. The extension element may extend from an interior surface 114 of tube 104 and may make contact with conductor 102. Liquid cooled conductor apparatus 100 may be disposed in an Electric Vehicle (EV) charging cable.

During the manufacturing of liquid cooled conductor apparatus 100, tube 104 and the extension element (e.g., first spoke 106, second spoke 108, third spoke 110, and fourth spoke 112) may be extruded on to conductor 102. Accordingly, tube 104 and the extension element may be made of one piece. For example, this may provide for a more efficient manufacturing process over a process where the tube 104 and the extension element comprise two different elements.

The extension element may be placed around conductor 102 disposed in tube 104 in order to keep conductor 102 centered in tube 104 for example. Coolant may be circulated in the space between conductor 102, tube 104, and the extension element. The extension element may improve consistency of heat transfer from conductor 102 to the coolant and may reduce potential hot spots in conductor 102. In the embodiment shown in FIG. 1, the extension element (e.g., first spoke 106, second spoke 108, third spoke 110, and fourth spoke 112) may extend directly from interior surface 114 of tube 104 and thus may be longitudinal such as ribs or other features that may keep the conductor centered while also allowing for sufficient coolant flow.

The coolant flowing in liquid cooled conductor apparatus 100 may be redirected (e.g., by a charging handle) into a coolant return tube that may be similar to liquid cooled conductor apparatus 100 for example. The coolant that was heated by conductor 102 may be returned to a coolant source where it may be re-cool. This re-cooled coolant may be reused in liquid cooled conductor apparatus 100 (e.g., circulated).

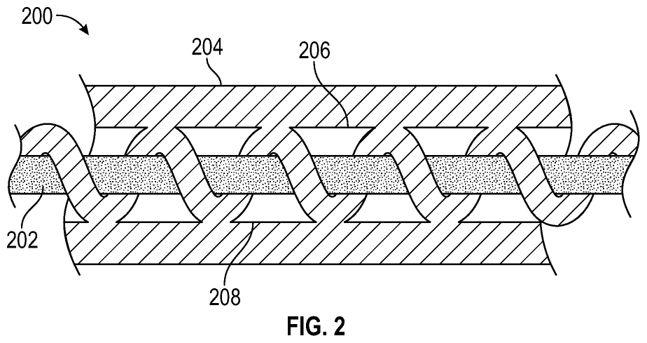

FIG. 2 shows a liquid cooled conductor apparatus 200. Apparatus 200 may comprise a conductor 202 (e.g., bare or insulated), a tube 204, and an extension element (e.g., a spoke 206). While FIG. 2 shows one spoke, embodiments of the disclosure may comprise any number of spokes and is not limited to one. Tube 204 may be disposed around conductor 202. The extension element may extend from an interior surface 208 of tube 204 and may make contact with conductor 202. Liquid cooled conductor apparatus 200 may be disposed in an EV charging cable.

During the manufacturing of liquid cooled conductor apparatus 200, tube 204 and the extension element (e.g., spoke 206) may be extruded on to conductor 202. Accordingly, tube 204 and the extension element may be made of one piece. For example, this may provide for a more efficient manufacturing process over a process where the tube 204 and the extension element comprise two different elements.

The extension element may be placed around conductor 202 disposed in tube 204 in order to keep conductor 202 centered in tube 204 for example. Coolant may be circulated in the space between conductor 202, tube 204, and the extension element. The extension element may improve consistency of heat transfer from conductor 202 to the coolant and may reduce potential hot spots in conductor 202. In the embodiment shown in FIG. 2, the extension element (e.g., spoke 206) may extend in a helically wound fashion around conductor 202 from interior surface 208 of tube 204 providing a feature that may keep conductor 202 centered while also allowing for sufficient coolant flow.

The coolant flowing in liquid cooled conductor apparatus 200 may be redirected (e.g., by a charging handle) into a coolant return tube that may be similar to liquid cooled conductor apparatus 200 for example. The coolant that was heated by conductor 202 may be returned to a coolant source where it may be re-cool. This re-cooled coolant may be reused in liquid cooled conductor apparatus 200 (e.g., circulated).

With the embodiment shown in FIG. 2, the extension element (e.g., spoke 206) may extend in a helically wound fashion around conductor 202 from interior surface 208 of tube 204. In the embodiment shown in FIG. 1, the extension element (e.g., first spoke 106, second spoke 108, third spoke 110, and fourth spoke 112) may extend directly from interior surface 114 of tube 104 and thus may be longitudinal such as ribs or other features. With either embodiment, the tube and the extension element may be extruded on to the conductor. Accordingly, the tube and the extension element may be made of one piece.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An apparatus comprising:
a conductor;
a tube disposed around the conductor; and
an extension element extending from an interior surface of the tube and making contact with the conductor.

2. The apparatus of claim 1, wherein the tube and the extension element are made of one piece.

3. The apparatus of claim 1, wherein the tube and the extension element are extruded on the conductor.

4. The apparatus of claim 1, wherein the extension element comprises at least one spoke extending directly from the interior surface of the tube.

5. The apparatus of claim 1, wherein the extension element comprises a plurality of spokes extending directly from the interior surface of the tube.

6. The apparatus of claim 1, wherein the extension element comprises at least one spoke extending helically from the interior surface of the tube.

7. The apparatus of claim 1, wherein the extension element comprises a plurality of spokes extending helically from the interior surface of the tube.

8. The apparatus of claim 1, wherein the apparatus is disposed in an Electric Vehicle (EV) charging cable.

9. The apparatus of claim 1, wherein a fluid is disposed between the conductor, the interior surface of the tube, and the extension element.

10. The apparatus of claim 9, wherein the fluid is caused to circulate.

11. The apparatus of claim 9, wherein the fluid cools the conductor.

12. The apparatus of claim 1, wherein the tube and extension element comprise silicon.

13. An apparatus comprising:
a conductor;
a tube disposed around the conductor; and
an extension element extending from an interior surface of the tube and making contact with the conductor wherein the extension element comprises a plurality of spokes extending directly from the interior surface of the tube.

14. The apparatus of claim 13, wherein the tube and the extension element are made of one piece.

15. The apparatus of claim 13, wherein the tube and the extension element are extruded on the conductor.

16. The apparatus of claim 13, wherein the apparatus is disposed in an Electric Vehicle (EV) charging cable.

17. An apparatus comprising:
a conductor;
a tube disposed around the conductor; and
an extension element extending from an interior surface of the tube and making contact with the conductor wherein the extension element comprises at least one spoke extending helically from the interior surface of the tube.

18. The apparatus of claim 17, wherein the tube and the extension element are made of one piece.

19. The apparatus of claim 17, wherein the tube and the extension element are extruded on the conductor.

20. The apparatus of claim 17, wherein the apparatus is disposed in an Electric Vehicle (EV) charging cable.
